(19) United States
(12) Patent Application Publication
(10) Pub. No.: US 2024/0346302 A1
(43) Pub. Date: Oct. 17, 2024

(54) HARDWARE REALIZATION OF NEURAL NETWORKS USING BUFFERS

(71) Applicant: PolyN Technology Limited, London (GB)

(72) Inventors: Nikolai KOVSHOV, Moscow (RU); Boris Maslov, Palmetto, FL (US); Aleksandrs Timofejevs, Riga (LV); Dmitri Godovskiy, Moscow (RU)

(21) Appl. No.: 18/135,100

(22) Filed: Apr. 14, 2023

(51) Int. Cl. G06N 3/065; G06N 3/0442

(52) U.S. Cl. CPC G06N 3/065; G06N 3/0442

(57) ABSTRACT

A method for hardware realization of neural networks executes at a computing device. The device obtains a neural network topology for a trained convolutional neural network that transforms a set of input tensors and generates a set of intermediate tensors. The device computes a measure of locality for tensors of the trained convolutional neural network based on dependencies between the set of input tensors and the set of intermediate tensors. The device transforms the trained convolutional neural network into an equivalent buffered neural network that includes a left subnetwork and a right subnetwork based on the neural network topology and the measure of locality. The left subnetwork and the right subnetwork are interconnected via a buffer. The device generates a schematic model for implementing the equivalent buffered neural network, including selecting component parameter values for neurons of the equivalent buffered neural network and connections between the neurons.

### TECHNICAL FIELD

The disclosed implementations relate generally to neural networks, and more particularly to methods and systems for hardware realization of neural networks using buffers.

### BACKGROUND

Some neural networks used in industrial applications have convolutional layers with relatively small kernels (e.g., kernels of size 3). A kernel is applied with a shift to an input data sequence. Similar computations are repeatedly performed on different data. Analog hardware can be used to realize these neural networks. In such hardware, it is important to reduce die size or the number of neurons. However, conventional digital hardware implementations only reduce memory size by reusing weight values in multiple calculations, without reducing die size.

### SUMMARY

Accordingly, there is a need for systems, methods and hardware implementations that reduce die size and/or number of neurons. Some implementations use buffers to substantially reduce the number of neurons in one or more layers of a neural network. Some implementations reuse computing elements for convolution computations with small kernel values, average pooling computations, and/or max pooling computations. These computations tend to produce multiple neurons with identical structures, when converted to analog form. Some implementations generate a transformed neural network that uses buffers. The transformed neural network is functionally equivalent to the input neural network. Some implementations insert buffers for tensors output by select layers (or portions) of a neural network and reduce the number of neurons. A smaller number of neurons can be used to perform computations on the data in the buffers. Some implementations select the layers of the neural network for inserting the buffers based on a measure of locality, as described below.

In accordance with some implementations, a method is provided for hardware realization of neural networks. The method includes obtaining a neural network topology for a trained convolutional neural network that transforms a set of input tensors and generates a set of intermediate tensors. The method also includes computing a measure of locality for tensors of the trained convolutional neural network based on dependencies between the set of input tensors and the set of intermediate tensors. The method also includes transforming the trained convolutional neural network into an equivalent (functionally or operationally equivalent) buffered neural network that includes a left subnetwork and a right subnetwork, based on the neural network topology and the measure of locality. The left subnetwork and the right subnetwork are interconnected via a buffer. The method also includes generating a schematic model for implementing the equivalent buffered neural network, including selecting component parameter values for neurons of the equivalent buffered neural network and connections between the neurons.

In some implementations, the method further includes associating the left subnetwork with a first aggregation rate and associating the right subnetwork with a second aggregation rate that is distinct from the first aggregation rate.

In some implementations, the trained convolutional neural network has an aggregation rate of operation equal to X and generates an intermediate tensor T of N data points each time it operates. The method further includes associating the buffer with the intermediate tensor T and defining the buffer to have a size equal to N. The method further includes defining the left subnetwork to generate M data points each time it operates and to have an aggregation rate of approximately X*N/M. The right subnetwork has an aggregation rate of X.

In some implementations, each intermediate tensor is associated with a corresponding spatial index range for input tensors that the respective intermediate tensor depends on. Computing the measure of locality includes computing the distance between the minimum spatial index and the maximum spatial index for the set of input tensors that the intermediate tensor depends on. Typically, intermediate tensors depend on a full range of input data. But each data point may depend on a limited range of the input data. Locality is the maximum range length among data elements of intermediate tensors.

In some implementations, each intermediate tensor is associated with a corresponding temporal index range for input tensors that the respective intermediate tensor depends on. Computing the measure of locality includes computing the distance between the minimum temporal index and the maximum temporal index for the set of input tensors that the intermediate tensor depends on.

In some implementations, computing the measure of locality is further based on parameters of convolution operations, including kernels, strides, padding, and dilation, for a predetermined set of layers of the trained convolutional neural network.

In some implementations, the size of the buffer is the size of an input tensor for the right subnetwork.

In some implementations, the method further includes selecting an intermediate tensor from the set of intermediate tensors based on the measure of locality, thereby determining the size of the buffer based on the size of the selected intermediate tensor.

In some implementations, the buffer is a rotating FIFO queue having a fixed length.

In some implementations, the method further includes selecting the input size of the left subnetwork based on the input shape of a portion of the trained convolutional neural network that corresponds to the left subnetwork. The reduced dimension shape corresponds to a dimension of data along which convolution or a pooling kernel is applied.

In some implementations, the input shape in reduced dimension for the trained convolutional neural network is X, the measure of locality for an intermediate tensor of the set of intermediate tensors selected as buffer tensor is Z. The method further includes selecting an input reduced dimension shape for the left subnetwork between Z and X. The reduced dimension shape corresponds to a dimension of data along which convolution or a pooling kernel is applied

In some implementations, the method further includes defining an input shape W for a reduced dimension of the left subnetwork, defining an approximate number of data points M that the left subnetwork generates using the equation M=1+(W−Z)*(N−1)/(X−Z), and computing an aggregation rate of operation for the left subnetwork based on M. The reduced dimension corresponds to a dimension of data along which convolution or a pooling kernel is applied.

In some implementations, transforming the trained convolutional neural network includes connecting the left subnetwork to a recurrent neural network (RNN) layer and connecting an output of the RNN layer to the right subnetwork. The reduced dimension index of the trained convolutional neural network is defined as a time series dimension for the RNN layer. The output of the RNN layer is flattened in time series dimension before being input to the right subnetwork.

In some implementations, transforming the trained convolutional neural network into the equivalent buffered neural network is performed in accordance with a determination that the measure of locality of a selected buffer tensor is below a predetermined threshold.

In some implementations, the method further includes computing a first measure of locality for a first portion of the trained convolutional neural network and a second measure of locality for a second portion of the trained convolutional neural network, based on the dependencies between the set of input tensors and the set of intermediate tensors. When the first measure of locality is below the predetermined threshold, the method includes transforming the first portion of the trained convolutional neural network into an equivalent neural network that includes the left subnetwork and the right subnetwork interconnected via the buffer. When the second measure of locality is greater than the predetermined threshold, the method interconnects the second portion of the trained convolutional network with the equivalent neural network to obtain the equivalent buffered neural network.

In some implementations, the neural network topology includes a first portion and a second portion. The first portion transforms a first set of input tensors and generates a first set of intermediate tensors. The second portion transforms a second set of input tensors and generates a second set of intermediate tensors. The method further includes computing (i) a first measure of locality for the first portion of the trained convolutional neural network based on the dependencies between the first set of input tensors and the set of intermediate tensors, and (ii) a second measure of locality for the second portion of the trained convolutional neural network, based on the dependencies between the second set of input tensors and the second set of intermediate tensors. The method further includes, when the first measure of locality is below a predetermined threshold, transforming the first portion of the trained convolutional neural network into a first equivalent neural network that includes a third subnetwork and a fourth subnetwork interconnected via a first buffer. The method further includes, when the second measure of locality is below the predetermined threshold, transforming the second portion of the trained convolutional neural network into a second equivalent neural network that includes a fifth subnetwork and a sixth subnetwork interconnected via a second buffer. The method further includes generating the equivalent buffered neural network based on the first equivalent neural network and the second equivalent neural network.

In some implementations, the method further includes computing a respective measure of locality for each layer of the trained convolutional neural network based on dependencies between the set of input tensors and a subset of the set of intermediate tensors. The method further includes transforming the trained convolutional neural network into the equivalent buffered neural network further based on the respective measure of locality for each layer of the trained convolutional neural network.

In some implementations, transforming the trained convolutional neural network into the equivalent buffered neural network includes splitting the trained convolutional neural network into the left subnetwork and the right subnetwork, based on the neural network topology and the measure of locality, recursively splitting the right subnetwork further into a right-left subnetwork and a right-right subnetwork based on another measure of locality for a layer in the right subnetwork and the neural network topology, and reducing the size of the buffer to a value that is the greater of the output size of the left subnetwork and the input size of the right-left subnetwork.

In another aspect, a system is provided for hardware realization of neural networks. The system includes one or more processors and memory storing one or more programs for execution by the one or more processors. The one or more programs include instructions for obtaining a neural network topology for a trained convolutional neural network that transforms a set of input tensors and generates a set of intermediate tensors. The one or more programs include instructions for computing a measure of locality for tensors of the trained convolutional neural network based on dependencies between the set of input tensors and the set of intermediate tensors. The one or more programs include instructions for transforming the trained convolutional neural network into an equivalent buffered neural network that includes a left subnetwork and a right subnetwork, based on the neural network topology and the measure of locality. The left subnetwork and the right subnetwork are interconnected via a buffer. The one or more programs include instructions for generating a schematic model for implementing the equivalent buffered neural network, including selecting component parameter values for neurons of the equivalent buffered neural network and connections between the neurons.

In another aspect, a non-transitory computer-readable storage medium is provided. The storage medium stores one or more programs configured for execution by one or more processors of a server system, the one or more programs including instructions, which, when executed by the one or more processors, cause the server system to perform any of the methods described herein.

In another aspect, a hardware apparatus is provided for implementing neural networks. The hardware apparatus includes a network of interconnected neurons comprising a plurality of subnetworks. The plurality of subnetworks includes a left subnetwork of neurons and a right subnetwork of neurons that are interconnected via a buffer. The left subnetwork of neurons and the right subnetwork of neurons are configured to operate at different frequencies and/or (ii) the right subnetwork is configured to operate conditionally based on the buffer.

In some implementations, the network of interconnected neurons is configured to implement a trained convolutional neural network.

In some implementations, the network of interconnected neurons corresponds to a plurality of layers of a convolutional neural network that includes a first layer of neurons and a second layer of neurons. The left subnetwork and the right subnetwork correspond to the first layer of neurons.

In some implementations, the buffer is a FIFO queue having a predetermined size.

In some implementations, the right subnetwork is reconfigurable to operate at different frequencies (e.g., depending on the application).

Some implementations include a buffered network for heart rate estimation based on PPG and accelerometer sensor data. The left subnetwork is a convolutional network that is configured to operate at a first frequency that is a first fraction of a predetermined frequency. The right subnetwork includes ResNet block elements and dense layers at its output, and the right subnetwork is configured to operate at a second frequency that is a fraction of the first frequency. In some implementations, the buffer is updated each time the left sub-network is executed and is configured to provide output data. In some implementations, the buffer is updated after the left sub-network is executed and output data meets a predetermined criteria. In some implementations, the network of interconnected neurons is configured to receive, at 25 Hz, PPG signals with 4 channels and accelerometer signals with 3 channels. The left subnetwork is configured to operate at a frequency that is approximately 2 Hz, receive 1-second long input data sequence so that its input is shaped (25, 7) and output is shaped (1, 4), where 1 represents the time dimension and 4 represents the channel's dimension. The buffer is a FIFO queue of size (40, 4) configured to update at a frequency that is approximately 2 Hz. The right subnetwork is configured to process (40, 4) buffer values as an input data sequence and its output has a shape (1) and represents heartrate. The right subnetwork is configured to operate at a frequency that is approximately 1 Hz.

Some implementations include a buffered network for voice activity detection. The left subnetwork is a convolutional network that is configured to operate at a first frequency that is a first fraction of a predetermined frequency. The right subnetwork comprises one or more elements for conditional execution that are configured to operate when a last value appended to the buffer exceeds a predetermined threshold. In some implementations, the network of interconnected neurons is configured to receive, at approximately 16 Hz, 1 channel of voice data. The left subnetwork is configured to operate at a frequency that is approximately 200 Hz, receive and process 10 millisecond long input data sequences, its input being shaped (160, 1) and output being shaped (1). The buffer is a FIFO queue of size (40, 1) configured to update at a frequency that is approximately 200 Hz. The right subnetwork is configured to operate when the last value appended to the buffer exceeds 0.5 feed, process (40, 1) buffer values as an input data sequence and its output has a shape (1) and represents voice activity confidence level.

Thus methods, systems, and hardware apparatus are disclosed for hardware realization of neural networks using buffers. Such hardware can have smaller die size and improve efficiency of neural networks.

Both the foregoing general description and the following detailed description are exemplary and explanatory, and are intended to provide further explanation of the invention as claimed.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a schematic diagram that illustrates locality of tensors of an example neural network, according to some implementations.

FIG. 2 is a block diagram illustrating an example computing device for hardware realization of neural networks using buffers in accordance with some implementations.

FIG. 3 shows an example neural network that uses micro-buffers, according to some implementations.

FIGS. 4A-4Q show a flow diagram illustrating example methods for hardware realization of neural networks using buffers in accordance with some implementations.

Like reference numerals refer to corresponding parts throughout the several views of the drawings.

### DESCRIPTION OF IMPLEMENTATIONS

A neural network can be viewed as a sequence of functions over input data tensors and intermediate data tensors. The tensors have one or more spatial dimensions. Each function outputs an intermediate data tensor or output data tensor. A convolutional neural network (CNN) operates on three-dimensional arrays or tensors. The tensors have three dimensions including two spatial dimensions, height and width, and a channel dimension. A third spatial dimension, depth, may be used for representing volumetric data (e.g., for medical imaging). A tensor associates with each spatial location a vector of features. The number of feature channels is arbitrary in general. For an image, feature vectors have three channels. Each channel captures intensity of primary colors for each pixel. Often, as for a standard image, there are two spatial dimensions. A CNN has a sequence of layers, and each layer takes as input a tensor and produces as output a tensor. Tensor dimensions can be assigned different meanings by different CNN architectures. For example, specific dimensions can be used to represent time rather than space.

For a given set of input tensors {J₁, . . . , Jₘ}, define a list of {T₁, . . . , Tₙ}, of intermediate data tensors. For some Tᵢ with a given tensor value Tᵢ[x, . . . ], suppose the first dimension corresponds to a spatial dimension that depends on multiple Jᵢ values. Some implementations define data locality as the distance between the minimum spatial index and the maximum spatial index for all Jᵢ values that Tᵢ[x, . . . ] depends on. The data locality (sometimes referred to as locality) can be the same for all values of some tensor Tᵢ. Typically, locality differs for some elements. For data locality of a tensor, the maximum of tensor element localities is used. For instance, consider a 2D convolution layer that uses a convolution kernel that is convolved with the input layer to produce a tensor of outputs. Suppose the kernel size equals 3. For the first layer, output data locality is 3 regardless of size of the actual dimensions.

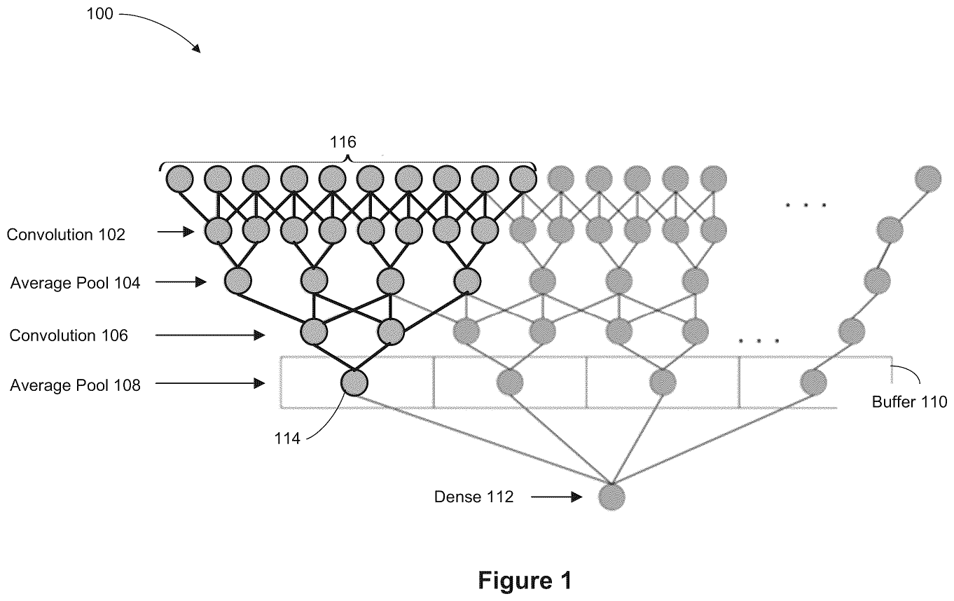

FIG. 1 is a schematic diagram that illustrates locality of tensors of an example convolutional neural network 100, according to some implementations. The example shows a first convolution layer 102, followed by a first average pooling layer 104, followed by a second convolution layer 106, followed by a second average pool layer 108, followed by a dense layer 112. Each bubble represents a data element of a tensor output by the corresponding layer. Each tensor includes a predetermined number of data elements. In FIG. 1, a tensor corresponds to a line of bubbles. Locality is determined for a tensor that is an output of a layer. Locality for a layer refers to the locality of a tensor that is output by the layer. For this example, data locality for the second average pool layer 108 is determined to be 10 as follows. Using the first tensor element 114 as an example, the value of the tensor element 114 is dependent on first ten input data elements 116, so the data locality for the second average pool layer 108 is 10. Any of the tensors for the second average pool layer 108 may be used for computing the locality for the layer. In the same way, a tensor element of the first average pool layer 104 is dependent on 4 of the input data points 116, so data locality for the first average pool layer 104 is 4. For the second convolution layer 106, the data locality is 8, because a tensor element depends on 8 of the input data elements 116. Based on the locality, a buffer 110 is inserted for the second average pool layer 108 preceding the dense layer 112.

For a series of layers, data locality depends on convolutional kernels, strides, and dilation parameters. Using a dense layer over spatial dimensions increases data locality, creating data with full dependence on the whole spatial axis. Data locality cannot be reduced by applying more operations over some internal tensor. Instead, data locality can only grow.

The transformations described herein can be used in low locality networks (or portions thereof). When a part of a convolutional network has low data locality, same computations are applied over spatial chunks of input data taken with a shift. In analog form, this can be viewed as applying some small analog sub-network multiple times and storing the results in some analog or digital memory.

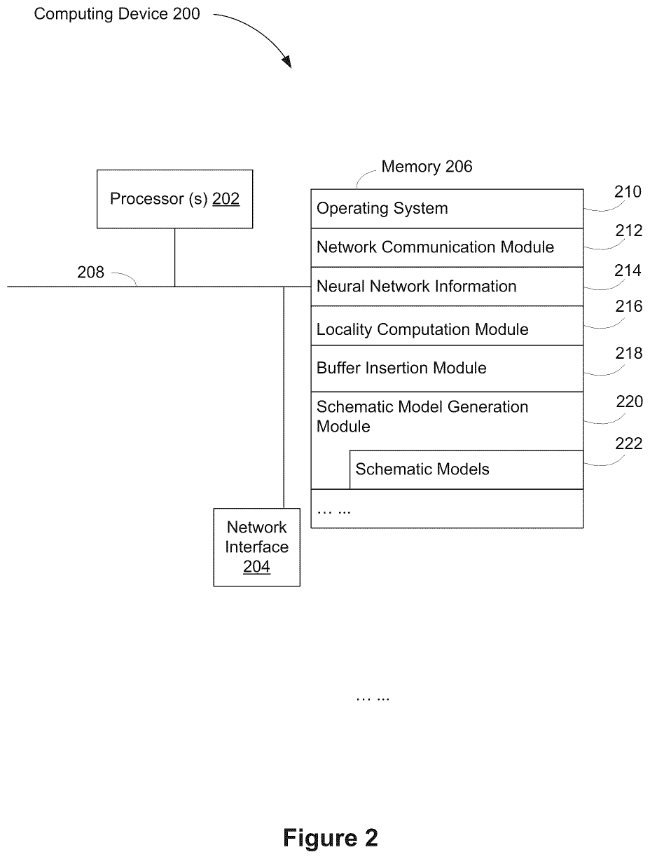

FIG. 2 is a block diagram illustrating an example computing device 200 for hardware realization of neural networks using buffers in accordance with some implementations. The computing device 200 typically includes one or more processing units (e.g., CPUs) 202, one or more network interfaces 204, memory 206, and one or more communication buses 208 for interconnecting these components (sometimes called a chipset).

The memory 206 includes high-speed random access memory, such as DRAM, SRAM, DDR RAM, or other random access solid state memory devices. In some implementations, the memory includes non-volatile memory, such as one or more magnetic disk storage devices, one or more optical disk storage devices, one or more flash memory devices, or one or more other non-volatile solid state storage devices. In some implementations, the memory 206 includes one or more storage devices remotely located from one or more processing units 202. The memory 206, or alternatively the non-volatile memory within the memory 206, includes a non-transitory computer readable storage medium. In some implementations, the memory 206, or the non-transitory computer readable storage medium of the memory 206, stores the following programs, modules, and data structures, or a subset or superset thereof:
an operating system 210, including procedures for handling various basic system services and for performing hardware dependent tasks;
a network communication module 212, which connects the computing device 200 to other devices via one or more network interfaces 204 (wired or wireless) and one or more networks, such as the Internet, other wide area networks, local area networks, metropolitan area networks, and so on;
neural network information 214, including topology information for one or more neural networks (e.g., a trained convolutional neural network), associated weights for connections, and/or information related to input tensors, intermediate tensors, and/or output tensors;
a locality computation module 216, which computes a measure of locality for tensors of a neural network based on dependencies between input tensors and intermediate tensors;
a buffer insertion module 218, which transforms a neural network into an equivalent buffered neural network with sub-networks interconnected via one or more buffers, based on the neural network topology and the measure of locality; and
a schematic model generation module 220, which generates schematic models 222 that implement the equivalent buffered neural network. The schematic model generation module 220 selects component parameter values for neurons of the equivalent buffered neural network and connections between the neurons.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, the memory 206 stores a subset of the modules and data structures identified above. In some implementations, the memory 206 stores additional modules and data structures not described above. In some implementations, a subset of the programs, modules, and/or data stored in the memory 206 can be stored on and/or executed by the computing device 200.

An example process for generating schematic models of implementing a neural network using the schematic model generation module 220 is described herein, according to some implementations. A target neural network is exported to SPICE (as a SPICE model) or a Verilog-A format, using a single neuron model (SNM), which is in turn exported to Cadence and full on-chip designs using a Cadence model. The Cadence model is cross validated against the initial neural network for one or more validation inputs. A math neuron is a mathematical function that receives one or more weighted inputs and produces a scalar output. In some implementations, a math neuron can have memory (e.g., long short-term memory (LSTM) or a recurrent neuron). A trivial neuron is a math neuron that performs a function, representing an ‘ideal’ mathematical neuron, V^{out}=f(Σ(Vᵢⁱⁿ·ωᵢ+bias), where f(x) is an activation function. A SNM is a schematic model with analog components (e.g., operational amplifiers, resistors R₁, . . . , Rₙ, and other components) representing a specific type of math neuron (for example, a trivial neuron) in schematic form. SNM output voltage is represented by a corresponding formula that depends on K input voltages and SNM component values V^{out}=g(Vᵢⁱⁿ, . . . , Vₖⁱⁿ, R₁, . . . , Rₙ). According to some implementations, with appropriate component values, an SNM formula is equivalent to a math neuron formula, with a desired weights set. In some implementations, the weight set is fully determined by resistors used in an SNM. A target neural network is a set of math neurons that have defined SNM representation, and weighted connections between them, forming a neural network. A target neural network follows several restrictions, such as an inbound limit (a maximum limit on the number of inbound connections for any neuron within the network), an outbound limit (a maximum limit on the number of outbound connections for any neuron within the network), and a signal range (e.g., all signals should be inside a pre-defined signal range). A preceding transformation may convert a desired neural network into a corresponding target network. A SPICE model is a SPICE Neural Network model of a target network, where each math neuron is substituted with corresponding one or more SNMs. A Cadence NN model is a Cadence model of the T-network, where each math neuron is substituted with a corresponding one or more SNMs. Also, as described herein, two networks L and M have mathematical equivalence if for all neuron outputs of these networks |Vᵢ^{L}−Vᵢ^{M}|<eps, where eps is relatively small (e.g., between 0.1-1% of the operating voltage range). Also, two networks L and M have functional equivalence if for a given validation input data set {I₁, . . . , Iₙ}, the classification results are mostly the same, i.e., P(L(Iₖ)=M(Iₖ))=1−eps, where eps is relatively small (“P” here measures the probability that the two networks return the same value for the same input value).

An example manual prototyping process used for generating a target chip model based on a SNM model on Cadence is described next, according to some implementations. Note that although the following description uses Cadence, alternate tools from Mentor Graphic design or Synopsys (e.g., Synopsys design kit) may be used in place of Cadence tools, according to some implementations. The process includes selecting SNM limitations, including inbound and outbound limits and signal limitation, selecting analog components (e.g., resistors, including a specific resistor array technology) for connections between neurons, and developing a Cadence SNM model. A prototype SNM model (e.g., a PCB prototype) is developed based on the SNM model on Cadence. The prototype SNM model is compared with a SPICE model for equivalence. In some implementations, a neural network is selected for an on-chip prototype, when the neural network satisfies equivalence requirements. Because the neural network is small in size, the preceding transformation can be hand-verified for equivalence. Subsequently, an on-chip SNM model is generated based on the SNM model prototype. The on-chip SNM model is optimized as possible, according to some implementations. In some implementations, an on-chip density for the SNM model is calculated prior to generating a target chip model based on the on-chip SNM model, after finalizing the SNM. During the prototyping process, a practitioner may iterate selecting a neural network task or application and a specific neural network (e.g., a neural network having on the order of 0.1 to 1.1 million neurons), performing transformation, building a Cadence neural network model, and designing interfaces and/or the target chip model.

### Example Buffered Networks

Some implementations transform an original neural network into a set of sub-networks. Data locality may be defined for each of the sub-networks. Those sub-networks having high data locality are transformed as is, and those sub-networks having low data locality are first converted to the same mathematical networks but with input shapes that corresponds to their data locality value. After this transformation, the neural networks may be transformed into an analog network. Resulting networks communicate using some intermediary memory device, such as a buffer.

To illustrate the transformations, suppose an input sequence has the shape (1000,1). Further suppose a neural network uses a one-dimensional convolution (sometimes referred to as Conv1D) layer that creates a convolution kernel that is convolved with the layer input over a single spatial (or temporal) dimension to produce a tensor of outputs. Suppose Conv1D (2, kernel_size=3) is followed by a dense layer Dense (1) having an input shape of (998,2). This network is split into two subnetworks. The first sub-network is Conv1D (kernel_size=3) with input shape (3,1), and second sub-network is dense (1) with input shape (998,2). The first sub-network is applied to the buffer of input data of length 3, for each time step. The second network is applied to the buffer of intermediate results of length 998, for each 1000 time steps or more often, in case the original network was applied with a shift value smaller than the window value.

The buffered network produces a mathematical structure that is mathematically approximately equal to the original network. The computational schema in Sub-network 1 (Input) produces buffer values and Sub-network 2 (Buffer) produces Output. This is mathematically equivalent to the computational schema Network (Input) producing Output. Typically, a buffered network includes multiple (e.g., more than 2) sub-networks with multiple buffers between them.

Each intermediate buffer is characterized by its length. Each sub-network is characterized by its own aggregation rate of operation in addition to its architecture.

Typically, data buffers are organized as rotating FIFO queues having fixed length.

Typically, the sizes of intermediate buffers are smaller or comparable to the size of the input window of the original network. A buffered network can be used to substantially reduce the amount of neurons by effectively re-using repeating computing elements. For instance, computations corresponding to Conv computations with small kernel value, Average Pooling computations, or Max Pooling computations, tend to produce multiple neurons with identical structure when directly converted to analog form due to low data locality of the output. Dense layer computations produce output of high data locality, so those layers may not benefit from the transformations described herein.

Overall energy consumption may be reduced by adjusting the aggregation rate of operation of some of the sub-networks. This energy consumption adjustment may depend on intermediate values obtained in one of the network's layers.

### Example Hardware Using Buffered Networks

According to some implementations, a hardware apparatus for implementing neural networks is provided. The hardware apparatus includes a network of interconnected neurons (e.g., the network 100) comprising a plurality of subnetworks. The plurality of subnetworks includes a left subnetwork of neurons (e.g., the layers 102, 104, 106, and 108) and a right subnetwork of neurons (e.g., the dense layer 112) that are interconnected via a buffer (e.g., the buffer 110). The left subnetwork of neurons and the right subnetwork of neurons are configured to operate at different frequencies and/or (ii) the right subnetwork is configured to operate conditionally based on the buffer. Conditional operation is possible with different frequencies. For example, the right subnetwork is executed each time the buffer becomes full, if the mean value of the buffer is >0.5, and the buffer is cleaned after the right network execution. The left network produces one buffer element each time it runs.

In some implementations, the network of interconnected neurons is configured to implement a trained convolutional neural network.

In some implementations, the network of interconnected neurons corresponds to a plurality of layers of a convolutional neural network that includes a first layer of neurons and a second layer of neurons. The left subnetwork and the right subnetwork correspond to the first layer of neurons. The first layer of neurons and the second layer of neurons may correspond to any intermediate layer of the network.

In some implementations, the buffer is a FIFO queue of a predetermined size.

In some implementations, the right subnetwork is reconfigurable to operate at different frequencies depending on the application. For example, the network is used to detect a dangerous state of an industrial mechanism based on vibration sensors patterns. In some situations, it is important to detect dangerous states every hour, while other situations require detection once every second.

Some implementations include a buffered network for heart rate estimation based on PPG and accelerometer sensor data. The left subnetwork is a convolutional network that is configured to operate at a first frequency that is a first fraction of a predetermined frequency. The right subnetwork includes ResNet block elements and dense layers at its output, and the right subnetwork is configured to operate at a second frequency that is a fraction of the first frequency. In some implementations, the buffer is updated each time when left sub-network is executed and is configured to provide output data. In some implementations, the buffer is updated after the left sub-network is executed and output data meets a predetermined criteria. In some implementations, the network of interconnected neurons is configured to receive, at 25 Hz, PPG signals with 4 channels and accelerometer signals with 3 channels. The left subnetwork is configured to operate at a frequency that is approximately 2 Hz, receive 1-second long input data sequences so that its input is shaped (25, 7) and output is shaped (1, 4), where 1 represents the time dimension and 4 represents the channel's dimension. The buffer is a FIFO queue of size (40, 4) configured to update at a frequency that is approximately 2 Hz. The right subnetwork is configured to process (40, 4) buffer values as input data sequences and its output has a shape (1) that represents heartrate. The right subnetwork is configured to operate at a frequency that is approximately 1 Hz.

In one example, a buffered network for heart rate estimation based on PPG and accelerometer sensor data is provided. The buffered network includes two sub-networks and one buffer. The input data series is 25 Hz PPG (4 channels) and accelerometer (3 channels) data. The pre-buffer sub-network is a convolutional network with a data locality of 25. It operates with a fixed frequency of 2 Hz and processes 1-second long input data sequences (so its input is shaped (25, 7)). Its output has a shape (1,4) where 1 represents the time dimension and 4 represents the channels dimension. The buffer is a FIFO queue of size (40,4) and is updated with a frequency of 2 Hz. The post-buffer sub-network is composed of ResNet block elements and dense layers at the output. It processes (40,4) buffer values as input data sequences and its output has shape (1) and stands for heartrate value. Its operating frequency may vary depending on the application. The default operating frequency for this sub-network is 1 Hz.

Some implementations include a buffered network for voice activity detection. The left subnetwork is a convolutional network that is configured to operate at a first frequency that is a first fraction of a predetermined frequency. The buffer is configured to operate at the first frequency. The right subnetwork comprises one or more elements for conditional execution that are configured to operate when a last value appended to the buffer exceeds a predetermined threshold (e.g., when the value is added to the buffer or only if the value is greater than 0.5). In some implementations, the network of interconnected neurons is configured to receive, at approximately 16 Hz, 1 channel voice data. The left subnetwork is configured to operate at a frequency that is approximately 200 Hz, receive and process 10 millisecond long input data sequences, its input being shaped (160, 1) and output being shaped (1). The buffer is a FIFO queue of size (40, 1) configured to update at a frequency that is approximately 200 Hz. The right subnetwork is configured to operate when the last value appended to the buffer exceeds 0.5 feed, process (40, 1) buffer values as input data sequence and its output has a shape (1) and represents voice activity confidence level.

In a second example, a buffered network for voice activity detection is provided. The buffered network includes two sub-networks and one buffer. The input data series is 16 kHz (1 channel) voice data. The pre-buffer sub-network is a convolutional network with data locality of 160. The sub-network operates with a fixed frequency of 200 Hz and processes 10 millisecond long input data sequences (so its input is shaped (160, 1)). Its output has a shape (1). The buffer is a FIFO queue of size (40,1) and is updated with a frequency of 200 Hz. The post-buffer sub-network has conditional execution. It is executed each time the last value appended to the buffer exceeds 0.5 feed. This is a way to reduce energy consumption of the overall network when sound level is low (e.g., low 90-95% of the time). The post-buffer network processes (40,1) buffer values as an input data sequence and its output has shape (1) and stands for voice activity confidence level.

### Micro-Buffering

In some implementations, instead of using intermediate buffers for selected layers, micro-buffers are distributed throughout the network. Each of the micro buffers stores enough elements to satisfy data locality on the current layer. In this way, it is possible to support large network-wise data locality by using a very limited number of additional neurons or buffer elements. FIG. 3 shows an example neural network 300 that uses micro-buffers, according to some implementations. The input data 302 is input to a first convolution layer 304, which is followed by a first average pooling layer 306, which is followed by a convolution layer 308, which is in turn followed by a second average pooling layer 310. A micro-buffer of size 2 is inserted for the first convolution layer 304, a micro-buffer of size 3 is inserted for the first average pool layer 306, and a micro-buffer of size 2 is inserted for the second convolution layer 308. In FIG. 3, each box is a data element or buffer memory cell for a data element. The sizes for the micro-buffers are determined in a manner similar to how locality is computed for tensors of layers, as described above in reference to FIG. 1. The micro-buffers may be associated with less than all of the tensors for a layer. Different number of micro-buffers may be inserted for different layers of a neural network.

Example Method for Hardware Realization of Neural Networks with Buffers

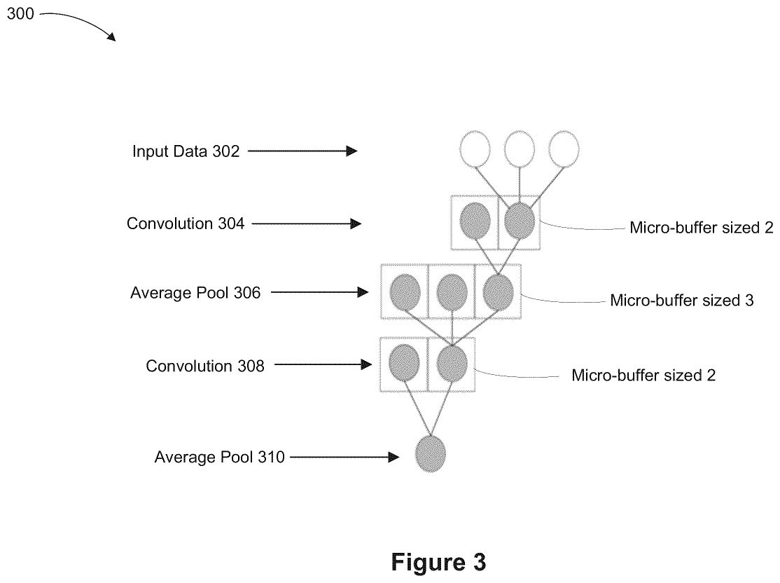

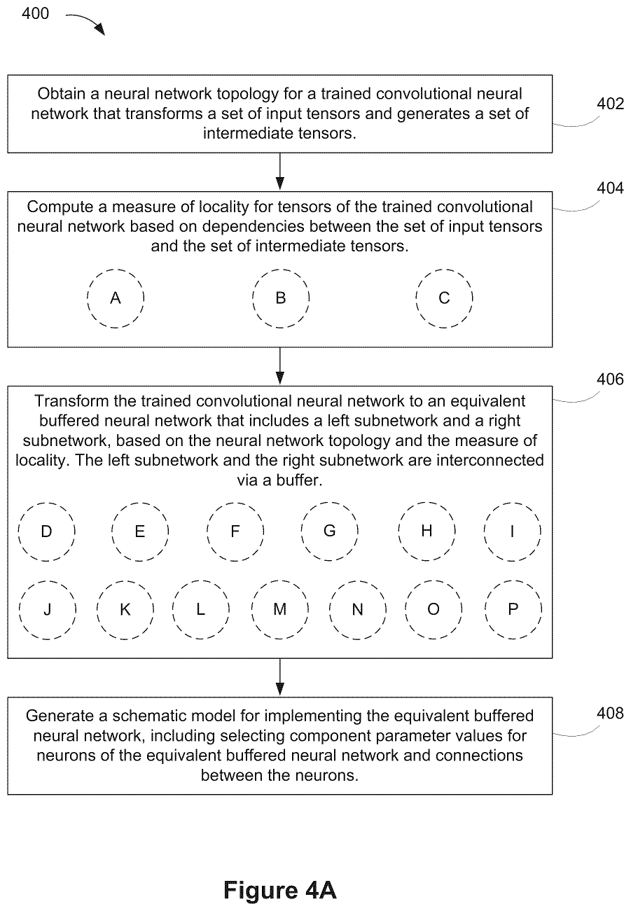

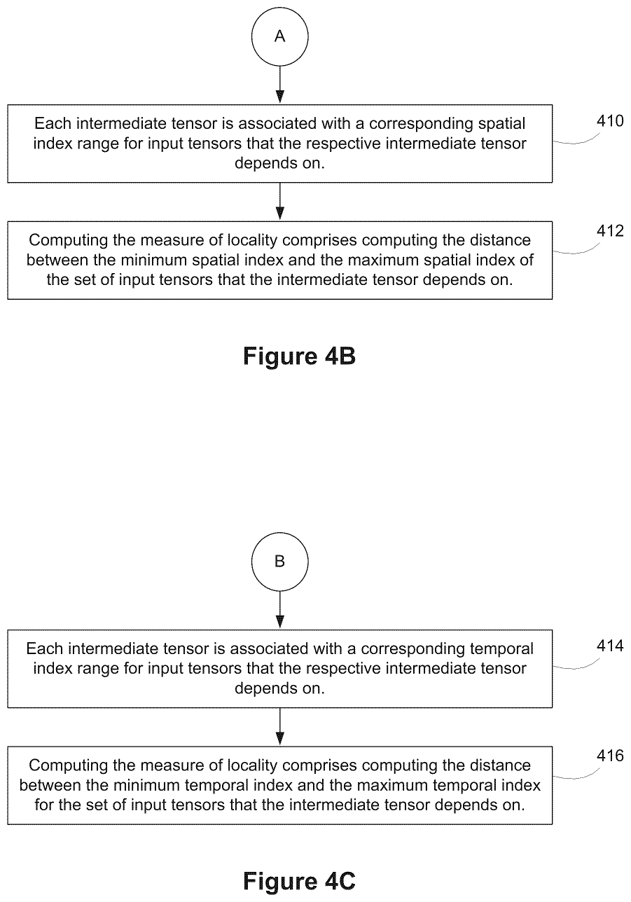

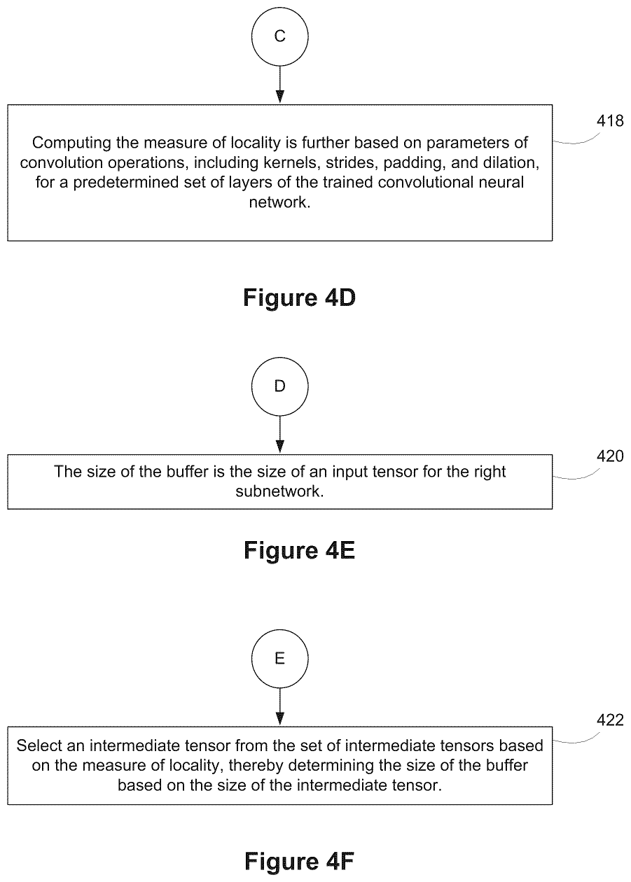

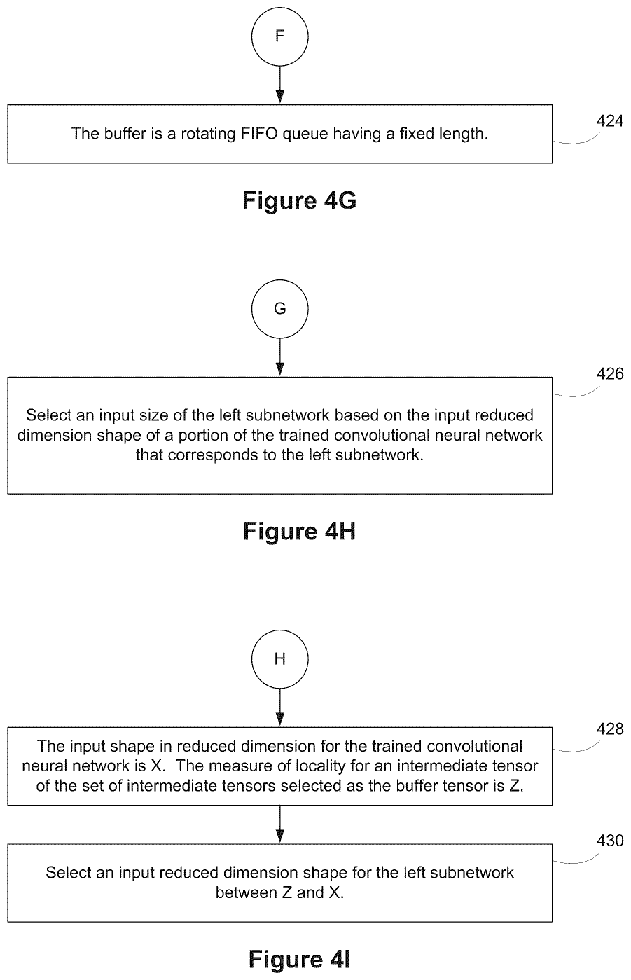

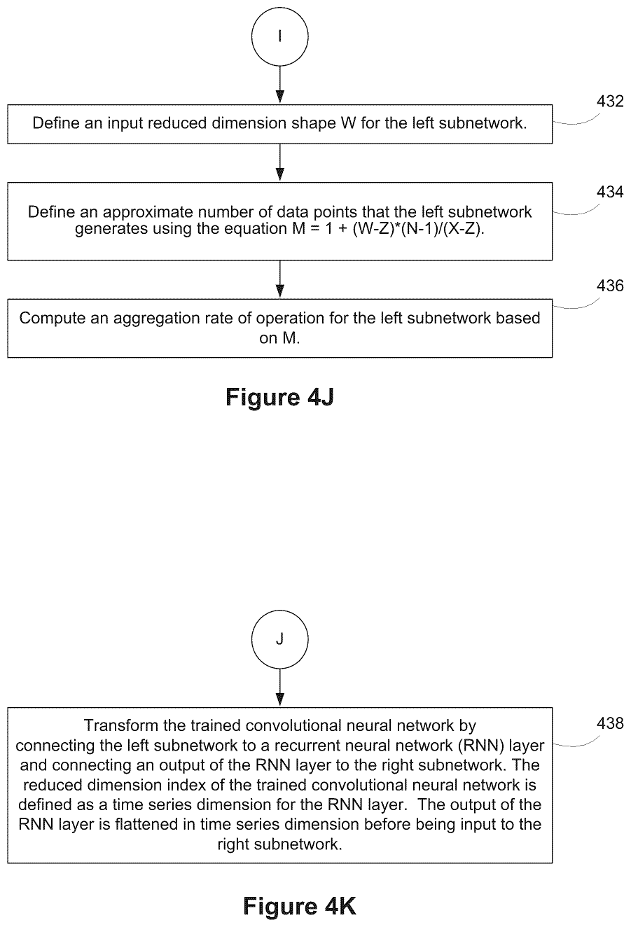

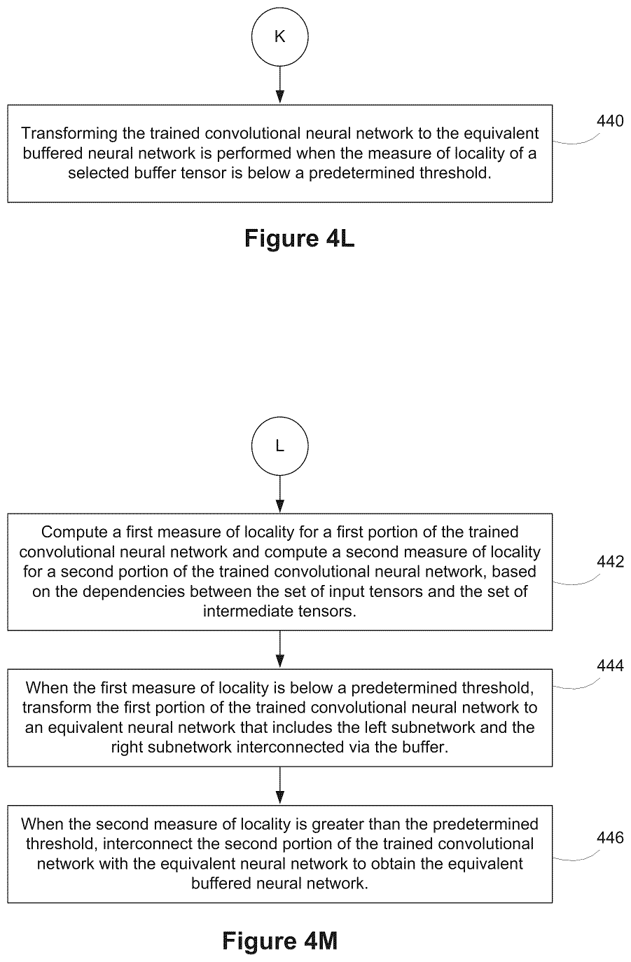

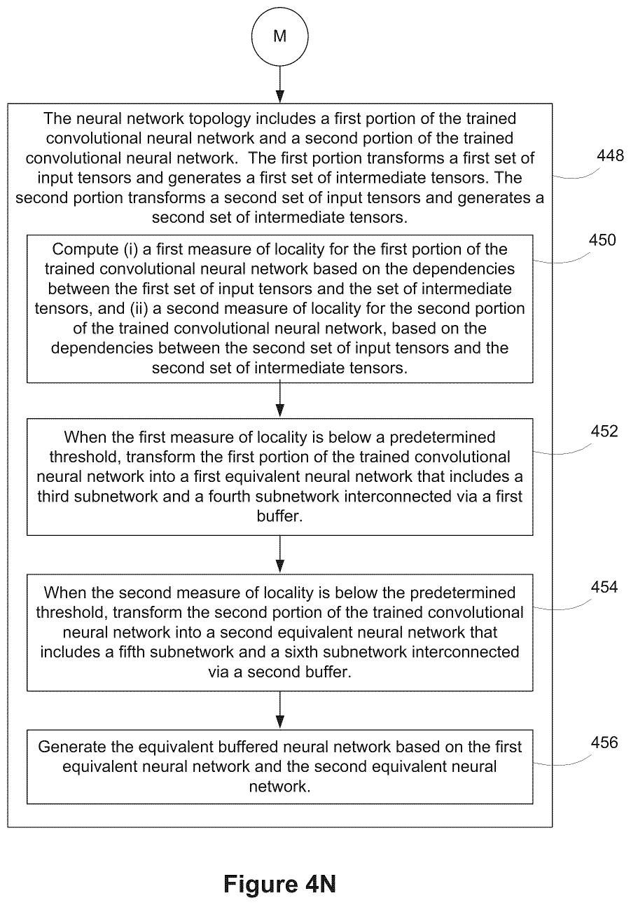

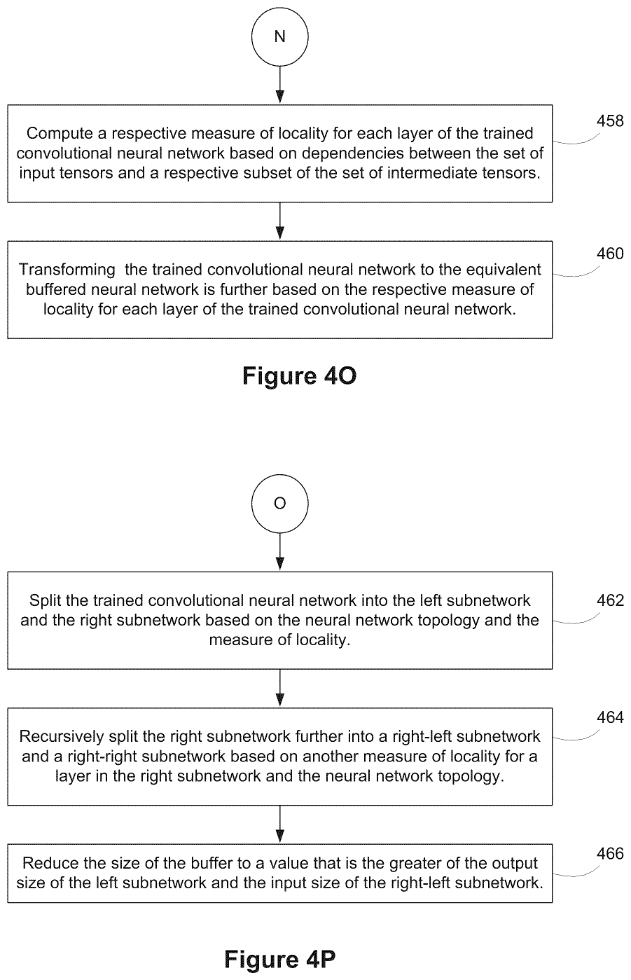

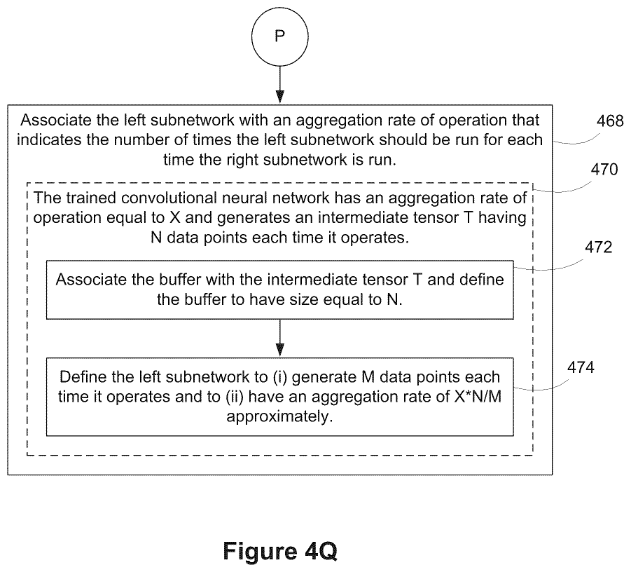

FIGS. 4A-4Q show a flow diagram illustrating a method 400 for hardware realization of neural networks, in accordance with some implementations. The method is performed by modules of the computing device 200.

The method includes obtaining (402) a neural network topology (e.g., the neural network topology stored in the neural network information 214) for a trained convolutional neural network that transforms a set of input tensors and generates a set of intermediate tensors.

The method also includes computing (404) (e.g., by the locality computation module 216) a measure of locality for tensors of the trained convolutional neural network based on dependencies between the set of input tensors and the set of intermediate tensors. Referring next to FIG. 4B, in some implementations, each intermediate tensor is associated (410) with a corresponding spatial index range for input tensors that the respective intermediate tensor depends on (looking at all of the elements of the respective intermediate tensor). Computing the measure of locality includes computing (412) the distance between the minimum spatial index and the maximum spatial index for the set of input tensors that the intermediate tensor (e.g., a scalar or single element of any intermediate tensor) depends on. Referring next to FIG. 4C, in some implementations, each intermediate tensor is associated (414) with a corresponding temporal index range for input tensors that the respective intermediate tensor depends on. Computing the measure of locality includes computing (416) the distance between the minimum temporal index and the maximum temporal index for the set of input tensors that the intermediate tensor (e.g., a scalar or single element of any intermediate tensor) depends on. Referring next to FIG. 4D, in some implementations, computing the measure of locality is further based (418) on parameters of convolution operations, including kernels, strides, padding, and dilation, for a predetermined set of layers of the trained convolutional neural network.

Referring back to FIG. 4A, the method also includes transforming (406) (e.g., by the buffer insertion module 218) the trained convolutional neural network into an equivalent (functionally or operationally equivalent) buffered neural network that includes a left subnetwork and a right subnetwork, based on the neural network topology and the measure of locality. The left subnetwork and the right subnetwork are interconnected via a buffer. Referring next to FIG. 4E, in some implementations, the size of the buffer is (420) the size of an input tensor for the right subnetwork. Referring next to FIG. 4F, in some implementations, the method further includes selecting (422) an intermediate tensor from the set of intermediate tensors based on the measure of locality, thereby determining the size of the buffer based on the size of the intermediate tensor. Referring next to FIG. 4G, in some implementations, the buffer is (424) a rotating FIFO queue having a fixed length. Referring next to FIG. 4H, in some implementations, the method further includes selecting (426) an input size of the left subnetwork based on the input shape of a reduced dimension of a portion of the trained convolutional neural network that corresponds to the left subnetwork. The reduced dimension corresponds to a dimension of data along which convolution or a pooling kernel is applied. Referring next to FIG. 4I, in some implementations, the input shape in reduced dimension for the trained convolutional neural network is (428) X, and the measure of locality for an intermediate tensor of the set of intermediate tensors selected as buffer tensor is (428) Z. The method further includes selecting (430) an input shape of a reduced dimension for the left subnetwork between Z and X. Referring next to FIG. 4J, in some implementations, the method further includes defining (432) an input shape W of a reduced dimension for the left subnetwork, defining (434) an approximate number of data elements M that the left subnetwork generates using the equation M=1+(W−Z)*(N−1)/(X−Z), and computing (436) an aggregation rate of operation for the left subnetwork based on M.

Referring next to FIG. 4K, in some implementations, transforming the trained convolutional neural network includes connecting (438) the left subnetwork to a recurrent neural network (RNN) layer and connecting an output of the RNN layer to the right subnetwork. The reduced dimension index of the trained convolutional neural network is defined as a time series dimension for the RNN layer. The output of the RNN layer is flattened in time series dimension before being input to the right subnetwork. The RNN layer provides a list of hidden states to the input of right sub-network.

Referring next to FIG. 4L, in some implementations, transforming the trained convolutional neural network into the equivalent buffered neural network is performed (440) when the measure of locality of a selected buffer tensor is below a predetermined threshold (e.g., 1/10th of an input shape in reduced dimension for the trained convolutional neural network X).

Referring next to FIG. 4M, in some implementations, the method further includes computing (442) a first measure of locality for a first portion of the trained convolutional neural network and a second measure of locality for a second portion of the trained convolutional neural network, based on the dependencies between the set of input tensors and the set of intermediate tensors. In accordance with a determination that the first measure of locality is below a predetermined threshold, the method includes transforming (444) the first portion of the trained convolutional neural network into an equivalent neural network that includes the left subnetwork and the right subnetwork interconnected via the buffer. When the second measure of locality is greater than the predetermined threshold, the method interconnects (446) the second portion of the trained convolutional network with the equivalent neural network to obtain the equivalent buffered neural network.

Referring next to FIG. 4N, in some implementations, the neural network topology includes (448) a first portion and a second portion of the trained convolutional neural network. The first portion transforms a first set of input tensors and generates a first set of intermediate tensors. The second portion transforms a second set of input tensors and generates a second set of intermediate tensors. The method further includes computing (450) (i) a first measure of locality for the first portion of the trained convolutional neural network based on the dependencies between the first set of input tensors and the set of intermediate tensors, and (ii) a second measure of locality for the second portion of the trained convolutional neural network, based on the dependencies between the second set of input tensors and the second set of intermediate tensors. The method further includes, when the first measure of locality is below a predetermined threshold, transforming (452) the first portion of the trained convolutional neural network into a first equivalent neural network that includes a third subnetwork and a fourth subnetwork interconnected via a first buffer. The method further includes, in accordance with a determination that the second measure of locality is below the predetermined threshold, transforming (454) the second portion of the trained convolutional neural network into a second equivalent neural network that includes a fifth subnetwork and a sixth subnetwork interconnected via a second buffer. The method further includes generating (456) the equivalent buffered neural network based on the first equivalent neural network and the second equivalent neural network.

Referring next to FIG. 4O, in some implementations, the method further includes computing (458) a respective measure of locality for each layer of the trained convolutional neural network based on dependencies between the set of input tensors and a respective subset of the set of intermediate tensors. The method further includes transforming (460) the trained convolutional neural network into the equivalent buffered neural network further based on the respective measure of locality for each layer of the trained convolutional neural network.

Referring next to FIG. 4P, in some implementations, transforming the trained convolutional neural network into the equivalent buffered neural network includes splitting (462) the trained convolutional neural network into the left subnetwork and the right subnetwork, based on the neural network topology and the measure of locality, recursively splitting (464) the right subnetwork further into a right-left subnetwork and a right-right subnetwork based on another measure of locality for a layer in the right subnetwork and the neural network topology, and reducing (466) the size of the buffer that interconnects the left subnetwork and the right-left subnetwork to a value that is the greater of the output size of the left subnetwork and the input size of the right-left subnetwork.

Referring next to FIG. 4Q, in some implementations, transforming the trained convolutional neural network into the equivalent buffered neural network includes associating (468) (e.g., by the buffer insertion module 218) the left subnetwork with a first aggregation rate that corresponds to the number of times the left subnetwork should be run for each time the right subnetwork runs. In some implementations, the trained convolutional neural network has (470) an aggregation rate of operation equal to X and generates an intermediate tensor T of N data points each time it operates. The method further includes associating (472) the buffer with the intermediate tensor T and defining the buffer to have a size equal to N. The method further includes defining (474) the left subnetwork to generate M data points each time it operates and to have an aggregation rate of approximately X*N/M.

Referring back to FIG. 4A, the method also includes generating (408) (e.g., by the schematic model generation module 220) a schematic model for implementing the equivalent buffered neural network, including selecting component parameter values for neurons of the equivalent buffered neural network and connections between the neurons.

Each of the above identified elements may be stored in one or more of the previously mentioned memory devices and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, the memory 206 stores a subset of the modules and data structures identified above. In some implementations, the memory 206 stores additional modules and data structures not described above.

Reference has been made in detail to implementations, examples of which are illustrated in the accompanying drawings. In the detailed description above, numerous specific details have been set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first device could be termed a second device, and, similarly, a second device could be termed a first device, without departing from the scope of the various described implementations. The first device and the second device are both devices, but they are not the same device.

The terminology used in the description of the various described implementations herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” means “when” or “upon” or “in response to determining” or “in response to detecting” or “in accordance with a determination that,” depending on the context. Similarly, the phrase “if it is determined” or “if [a stated condition or event] is detected” means “upon determining” or “in response to determining” or “upon detecting [the stated condition or event]” or “in response to detecting [the stated condition or event]” or “in accordance with a determination that [a stated condition or event] is detected,” depending on the context.

For situations in which the systems discussed above collect information about users, the users may be provided with an opportunity to opt in/out of programs or features that may collect personal information (e.g., information about a user's preferences or usage of a smart device). In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A method for hardware realization of neural networks, comprising:
obtaining a neural network topology for a trained convolutional neural network that transforms a set of input tensors and generates a set of intermediate tensors;
computing a measure of locality for tensors of the trained convolutional neural network based on dependencies between the set of input tensors and the set of intermediate tensors;
transforming the trained convolutional neural network into an equivalent buffered neural network that includes a left subnetwork and a right subnetwork, based on the neural network topology and the measure of locality, wherein the left subnetwork and the right subnetwork are interconnected via a buffer; and
generating a schematic model for implementing the equivalent buffered neural network, including selecting component parameter values for neurons of the equivalent buffered neural network and connections between the neurons.

2. The method of claim 1, wherein:
each intermediate tensor is associated with a corresponding spatial index range for input tensors that the respective intermediate tensor depends on; and
computing the measure of locality for an intermediate tensor comprises computing a distance between a minimum spatial index and a maximum spatial index of input tensors that the intermediate tensor depends on.

3. The method of claim 1, wherein:
each intermediate tensor is associated with a corresponding temporal index range for input tensors that the respective intermediate tensor depends on; and
computing the measure of locality for an intermediate tensor comprises computing a distance between a minimum temporal index and a maximum temporal index of input tensors that the intermediate tensor depends on.

4. The method of claim 1, wherein computing the measure of locality is further based on parameters of convolution operations, including kernels, strides, padding, and dilation, for a predetermined set of layers of the trained convolutional neural network.

5. The method of claim 1, wherein a size of the buffer is the size of an input tensor for the right subnetwork.

6. The method of claim 1, further comprising:
selecting an intermediate tensor from the set of intermediate tensors based on the measure of locality for intermediate tensors, thereby determining a size of the buffer based on the size of the selected intermediate tensor.

7. The method of claim 1, wherein the buffer is a rotating FIFO queue having a fixed length.

8. The method of claim 1, further comprising:
selecting an input size of the left subnetwork based on input shape of a reduced dimension shape of a portion of the trained convolutional neural network that corresponds to the left subnetwork, wherein the reduced dimension shape corresponds to a dimension of data along which convolution or a pooling kernel is applied.

9. The method of claim 1, wherein input shape in reduced dimension for the trained convolutional neural network is X, the measure of locality for an intermediate tensor of the set of intermediate tensors selected as buffer tensor is Z, and the method further comprises:
selecting an input reduced dimension shape for the left subnetwork between Z and X, wherein the reduced dimension shape corresponds to a dimension of data along which convolution or a pooling kernel is applied.

10. The method of claim 1, further comprising:
defining an input shape W for of a reduced dimension shape of the left subnetwork, wherein the reduced dimension shape corresponds to a dimension of data along which convolution or a pooling kernel is applied;
defining an approximate number of data points M that the left subnetwork generates using an equation M=1+(W−Z)*(N−1)/(X−Z); and
computing an aggregation rate of operation for the left subnetwork based on M.

11. The method of claim 1, wherein transforming the trained convolutional neural network comprises:
connecting the left subnetwork to a recurrent neural network (RNN) layer and connecting an output of the RNN layer to the right subnetwork, wherein a reduced dimension index of the trained convolutional neural network is defined as a time series dimension for the RNN layer, and the output of the RNN layer is flattened in time series dimension before being input to the right subnetwork.

12. The method of claim 1, wherein transforming the trained convolutional neural network to the equivalent buffered neural network is performed in accordance with a determination that the measure of locality of a selected buffer tensor is below a predetermined threshold.

13. The method of claim 1, further comprising:
computing a first measure of locality for a first portion of the trained convolutional neural network and a second measure of locality for a second portion of the trained convolutional neural network, based on the dependencies between the set of input tensors and the set of intermediate tensors;
in accordance with a determination that the first measure of locality is below a predetermined threshold, transforming the first portion of the trained convolutional neural network into an equivalent neural network that includes the left subnetwork and the right subnetwork interconnected via the buffer; and
in accordance with a determination that the second measure of locality is above the predetermined threshold, interconnecting the second portion of the trained convolutional network with the equivalent neural network to obtain the equivalent buffered neural network.

14. The method of claim 1, wherein the neural network topology includes a first portion of the trained convolutional neural network and a second portion of the trained convolutional neural network, wherein the first portion transforms a first set of input tensors and generates a first set of intermediate tensors, the second portion transforms a second set of input tensors and generates a second set of intermediate tensors, and the method further comprises:
computing (i) a first measure of locality for the first portion of the trained convolutional neural network based on the dependencies between the first set of input tensors and the set of intermediate tensors, and (ii) a second measure of locality for the second portion of the trained convolutional neural network, based on the dependencies between the second set of input tensors and the second set of intermediate tensors;
in accordance with a determination that the first measure of locality is below a predetermined threshold, transforming the first portion of the trained convolutional neural network into a first equivalent neural network that includes a third subnetwork and a fourth subnetwork interconnected via a first buffer;
in accordance with a determination that the second measure of locality is below the predetermined threshold, transforming the second portion of the trained convolutional neural network into a second equivalent neural network that includes a fifth subnetwork and a sixth subnetwork interconnected via a second buffer; and
generating the equivalent buffered neural network based on the first equivalent neural network and the second equivalent neural network.

15. The method of claim 1, further comprising:
computing a respective measure of locality for each layer of the trained convolutional neural network based on dependencies between the set of input tensors and a respective subset of the set of intermediate tensors; and
transforming the trained convolutional neural network into the equivalent buffered neural network further based on the respective measure of locality for each layer of the trained convolutional neural network.

16. The method of claim 1, wherein transforming the trained convolutional neural network into the equivalent buffered neural network comprises:
splitting the trained convolutional neural network into the left subnetwork and the right subnetwork, based on the neural network topology and the measure of locality;
recursively splitting the right subnetwork further into a right-left subnetwork and a right-right subnetwork based on another measure of locality for a layer in the right subnetwork and the neural network topology; and
reducing a size of the buffer to a value that is the greater of the output size of the left subnetwork and the input size of the right-left subnetwork.

17. The method of claim 1, wherein transforming the trained convolutional neural network further comprises:
associating the left subnetwork with an aggregation rate of operation that indicates a number of times the left subnetwork should be run for each time the right subnetwork is run.

18. The method of claim 17, wherein the trained convolutional neural network has an aggregation rate of operation X, generates an intermediate tensor T of N data points each time it operates, and the method further comprises:
associating the buffer with the intermediate tensor T and defining the buffer to have size equal to N;
defining the left subnetwork to generate M data points each time it operates and to have an aggregation rate of approximately X*N/M; and
defining the right subnetwork to have an aggregation rate of X.

19. A system, comprising:
one or more processors; and
memory storing one or more programs for execution by the one or more processors, the one or more programs including instructions for:
obtaining a neural network topology for a trained convolutional neural network that transforms a set of input tensors and generates a set of intermediate tensors;
computing a measure of locality for tensors of the trained convolutional neural network based on dependencies between the set of input tensors and the set of intermediate tensors;
transforming the trained convolutional neural network into an equivalent buffered neural network that includes a left subnetwork and a right subnetwork, based on the neural network topology and the measure of locality, wherein the left subnetwork and the right subnetwork are interconnected via a buffer; and
generating a schematic model for implementing the equivalent buffered neural network, including selecting component parameter values for neurons of the equivalent buffered neural network and connections between the neurons.

20. A non-transitory computer-readable storage medium, storing one or more programs configured for execution by one or more processors of a server system, the one or more programs including instructions, which when executed by the one or more processors cause the server system to:
obtain a neural network topology for a trained convolutional neural network that transforms a set of input tensors and generates a set of intermediate tensors;
compute a measure of locality for tensors of the trained convolutional neural network based on dependencies between the set of input tensors and the set of intermediate tensors;
transform the trained convolutional neural network into an equivalent buffered neural network that includes a left subnetwork and a right subnetwork, based on the neural network topology and the measure of locality, wherein the left subnetwork and the right subnetwork are interconnected via a buffer; and
generate a schematic model for implementing the equivalent buffered neural network, including selecting component parameter values for neurons of the equivalent buffered neural network and connections between the neurons.
